(19) United States
(12) Patent Application Publication
(10) Pub. No.: US 2002/0147963 A1
(43) Pub. Date: Oct. 10, 2002

(54) Method and apparatus for generating machine control instructions

(76) Inventor: Rusty Shawn Lee, Honolulu, HI (US)

Correspondence Address: Rusty S. Lee, 1525 Wilder Ave. #606, Honolulu, HI, 96822, US

(21) Appl. No.: 09/828,681

(22) Filed: Apr. 9, 2001

(51) Int. Cl. G06F 9/44

(52) U.S. Cl. 717/108

(57) ABSTRACT

A method and apparatus are presented for automatically generating machine control instructions in a general and flexible manner. The generated instructions can be edited directly or in a high-level graphical interface. Any changes made either locally or by remote users over a network to the generated instructions or their abstract representations will be automatically reflected in both the abstract representations and the generated instructions. This allows the use of a high-level tool for rapid code generation even after modification of previously generated instructions. Furthermore, the execution of the generated code can be traced through and monitored through the same high-level graphical model.

### CROSS-REFERENCE TO RELATED APPLICATIONS Not Applicable.

### STATEMENT REGARDING FEDERALLY SPONSORED RESEARCH OR DEVELOPMENT Not Applicable.

### REFERENCE TO A MICROFICHE APPENDIX Not Applicable.

### BACKGROUND OF THE INVENTION

This invention relates to computer programming, and more particularly to computer aided software development.

As software systems have become increasingly complex, so has the software development process. The purpose of the invention is to provide a way to quickly and easily develop, modify, and debug software without sacrificing efficiency or quality of code.

In modern development environments, it is quite common to find tools that permit developers to select graphic user interface elements from a collection and place them on the screen in the desired configuration. Borland JBuilder, Metrowerks Java, and Microsoft Visual Studio all include tools that can generate basic control code for the graphical elements as well as skeleton code for linking them with the rest of the application. One of the limitations of these products is that modifying the generated code limits or prevents further automatic code generation. These products also limit the type of code generated to code for a predefined set of user interface elements. A person of ordinary skill in the art cannot add or modify this predefined set of user interface elements to account for new types of user interfaces.

Another type of automatic code generation system uses the construction of a flowchart representing either the flow of control or the flow of data in the software program. The problem with this approach is that each step in the flowchart can only proceed to a small number of fixed choices predefined as possible next steps. This limits the flexibility of developers, since the makers of the code generation system cannot possibly foresee all the possible desired transitions between steps.

Other prior art designed for easing software development includes software such as Rational Software Corporation's Rational Rose that generates code based on a formal object model. Such techniques require the rigorous formation of such models, both constraining the user to such models and preventing the user from creating new representations. Since different applications have different requirements, their optimal representations vary. There is no single representation that can be said to be optimal in all cases, so constraining the user to a single representation constrains the development process. Such constraints can even limit the efficiency or functionality of the resulting software since the representation limits the scope of data objects so that code from part of the object model is prevented from directly communicating with code and data from other parts of the object model.

All of the above types of systems also suffer from the problem of only giving the user limited interfaces for development. The prior art uses a graphical interface or a source-based interface for developing software. However, in neither case will editing the generated code properly update the representation in the original interface. This limits the utility of the code generation environment, since developers cannot go back and forth between generated and pre-generated representations. Although some code generation systems provide prototyping capabilities to allow certain elements to be tested without the rest of the system working, they do not allow these elements to be debugged and the changes reincorporated into the original representation, and none of the prior art allows partial testing to be done universally with all generated code. These systems also reduce the efficiency of the generated code, since form and ease of development are given priority over code efficiency. Although this is acceptable for rapid prototyping, it is generally known in the art that production code should be as efficient as possible to minimize the hardware resources needed to run the finished program.

Prior art also includes incremental compilers designed to compile only the code that has been recently modified (U.S. Pat. No. 5,170,465), but these operate on computer source code, and cannot be used on any other representations such as those used by automatic code generation systems.

Another problem with existing automatic code generation systems is the lack of portability. Systems created for one computer architecture, such as Microsoft's Windows platform or Sun's Java platform, must be modified to produce code for a different architecture. These modifications are typically extensive and require large teams of skilled programmers to implement. Additionally, the existing code generation systems are designed solely for generating instructions for controlling computer chips, and cannot be used to generate code for similar mechanical or electronic devices.

### BRIEF SUMMARY OF THE INVENTION

In accordance with one embodiment of the present invention is a software development system that generates machine code instructions in a flexible and general manner to substantially reduce the time and resources required to produce production-quality software. The current invention uses objects that contain machine control instructions. These objects can be freely modified and connected to each other both graphically and programmatically without limiting further code generation.

The machine control instructions contained in the object define the actions of that object. Each object has a number of inputs and outputs, and these can be connected to the inputs and outputs of other objects to form a network of objects. Since these connections are general-purpose connections independent of the connected objects, any of the objects can be connected to each other, unlike the prior art that limits connections to certain pre-defined classes of objects or to a pre-defined set of state transitions. This independence between connections and objects allows the generation system to run on any platform the objects contain generated machine code instructions for. This is not limited to computer instructions and can include control information for mechanical and electronic devices as well.

Unlike the prior art, this network of generic connections between objects allows any desired interface to be used to provide the desired representation for developing, editing, testing, and debugging code. This means that the user can begin developing part of an application graphically, test and monitor the execution of that part in a virtual reality environment, fix bugs in the generated source code, and continue developing the application graphically with the source code changes reflected in the graphical environment.

This allows any desired part of the system to be tested and debugged incrementally, without requiring the system to be completely coded. Unlike the prior art, this feature is not limited to specific parts of the system, and can be applied to any desired portion of the system. Furthermore, these changes will be automatically reflected in any other representation the user chooses to view or edit the system with. This allows incremental development to occur at every step of the development process, unlike the prior art which supports incremental development only for compilation of computer source code.

This also allows parts of the system to be tested, edited, and debugged on remote machines over a network by several users simultaneously. The changes made are reflected immediately in each user's chosen representation.

Unlike the prior art, the current invention is not limited to graphic user interface objects but can manipulate objects of any kind, including but not limited to data objects and control objects. Unlike the prior art, these objects can also be modified, combined or enhanced to produce new objects. These new objects are not limited by any predefined constraints. This allows the generated machine control instructions to be very efficient, since they are not constrained to a rigid formal model or representation.

### BRIEF DESCRIPTION OF THE SEVERAL VIEWS OF THE DRAWING

The novel features believed characteristic of the invention are set forth in the appended claims. The invention itself, however, as well as other features and advantages thereof, will be best understood by reference to a detailed description of a specific embodiment which follows, when read in conjunction with the accompanying drawings, wherein:

FIG. 1 is a table of the initial header fields of objects in the database and their data types;

FIG. 2 is a simplified drawing of the editor;

FIG. 3 is a simplified drawing of the editor with a node selected;

FIG. 4 is a simplified drawing of the editor after decomposing generated code; and

FIG. 5 is a simplified drawing of the debugger during execution of code.

### DETAILED DESCRIPTION OF THE INVENTION

In accordance with one embodiment of the present invention is a software development system including an operating system, compiler, debugger, and editor. The operating system includes a library of objects in a database. The present embodiment also allows the option of using the file system as a database for storing objects by storing them as files on a disk. Each object in the database is indexed by name and contains header information for the object plus one or more sets of machine control instructions. In the present embodiment, the machine control instructions consist of executable code for a hardware or software platform or source code for a programming language. An alternative embodiment includes machine control instructions that consist of electrical signals or representations of mechanical movements for controlling electronic or mechanical devices. The machine control instructions for each platform can contain multiple functions, but each version of the machine control instructions stored in the object must contain the same functions with the same input and output parameters.

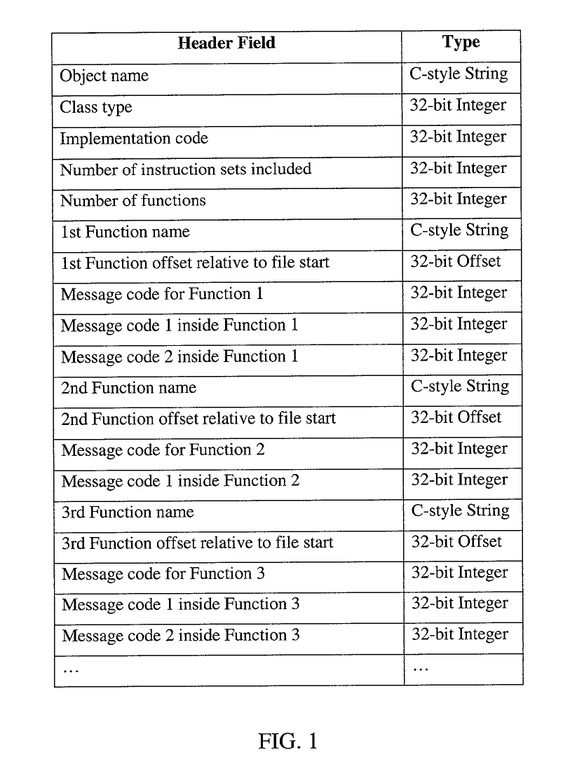

The header information contains the name of the object, the input and output parameter types for each function contained in the object, a 32-bit identifier for the category of the object called the class type, a 32-bit identifier for the implementation called the implementation code, a 32-bit identifier for the version number, plus any additional information necessary for the appropriate operating system and hardware to properly load and link any executable code, and the header can store additional information if needed. An example header is shown in FIG. 1. The input and output parameter types are labeled with a particular 32-bit integer called the message code. This message code is used so that an input and output can only be connected if they have the same message code. Each object with the same class type has some set of functions with input and output parameters defined by that class type, although individual implementations of a class type may also include additional functions and input and output parameters. There are several default class types, such as ‘fsys’ for filesystems and ‘wind’ for window objects, but developers may define their own class types as well. The implementation code is different for each implementation of a given class type. In the current embodiment these are guaranteed to be unique. This is accomplished by mapping each implementation code to the 32-bit IP address that it represents. Each byte in the implementation code corresponds to the value of the appropriate octet in the IP address. Each unique IP address represents a different implementation, and developers use one of their globally assigned IP addresses to represent each one of their implementations of a class type. Since no company or individual is likely to have more implementations of any given class type than they have IP addresses, this system guarantees two developers will not use the same implementation code. Since the class type and implementation code together identify unique objects, the developer can use the same implementation code for multiple objects as long as the objects have different class types. New versions of an implementation do not receive their own implementation code, but rather they receive successive increasing version numbers.

The database contains objects of many levels of complexity, including primitive objects that contain code for a single instruction. For example, the adder object simply contains a single function that adds two integers together. The input parameters are the two integers to add and the output parameter is the integer result. A more complicated object is the gzip object which contains a compress function for compressing data and a decompress function for decompressing data. For both functions the input parameters are a pointer to the compressed or uncompressed data in memory and the size of that data, and there are no output parameters. Another example is the file block object that contains a read function for reading a file into memory and a write function for writing memory into a file. Both functions take a file name as an input parameter and the write function also has input parameters that consist of a pointer to the data to write and the size of that data. The read function outputs the size of the data and a pointer to that data, and the write function outputs the status of the write. Outputting a null pointer or a negative data size is used to indicate a failure of the read function. The file object also maintains some internal state, caching reads for efficiency purposes.

In turn, some of these objects call other objects to do work or retrieve data. These calls are themselves additional output parameters from the calling object and are input parameters to the called objects. In the current embodiment, these are references to a specific object retrieved by querying the operating system at run-time for a specific class type of object and storing the reference for future calls. When objects require a separate instantiation of the called object, a new query is made to the operating system requesting a new distinct object of a specific class type. The header information for each object also includes information about which object class types that object calls. This information is used by the operating system to ensure that the appropriate objects are available and to retrieve them automatically or inform the user if the objects that the original object is dependent on are not available. The editor also uses this information when determining dependencies of objects. The editor is discussed in more detail below.

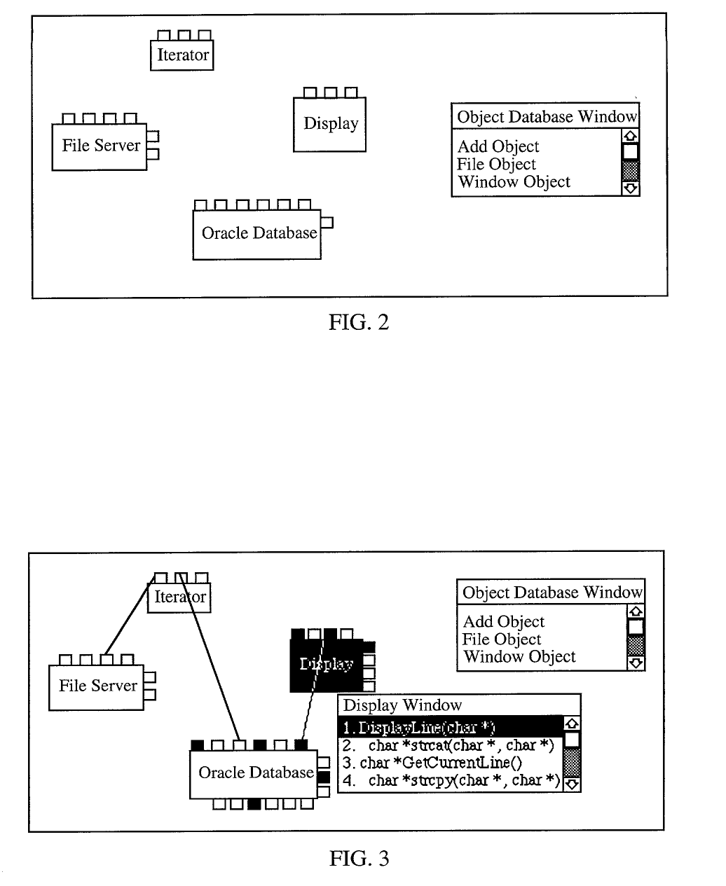

In the current embodiment, the editor is a graphical program that allows the construction of networks of objects. The editor has two windows, one that displays the current network and one which displays a list of the objects available to use, as shown in FIG. 2. The list of objects is a list of all the objects in the database, made by retrieving their names from the object database. The user selects an object by clicking on it with a mouse. The editor reads in this user input and loads the header information for the selected object from the database. If the header information contains a bitmap, that bitmap is used to draw the object on the screen, otherwise a rectangle with the object's name inside is used to draw the object on the screen. The object can be dragged with the mouse to any location in the network window. To add an object to the network window, the user drags the object from the list window to the network window. The user can select multiple objects by shift-clicking on them successively. The currently selected objects can be deleted from the network window via a menu command. The keyboard or an alternative input device such as a graphics tablet can be used instead of the mouse if desired, as is a standard property of the input device layer of most operating systems.

When an object is added to the network, the editor will automatically add any objects that the original object is dependent on, and any input or output parameters marked as dependent in the object's header are automatically connected to the parameters in the object that they are dependent on in the network. Future user inputs may alter these connections in the same way new connections are made and modified, as described below.

The connections between objects are displayed as lines connecting the representations of the objects in the editor. When an object is selected, a new window appears that contains a list of the functions in the object. Each function in the list is followed by an indented list of each call to another object within that function. These calls to other objects are output parameters and the functions have input parameters. Each output parameter in the list can be linked to an input parameter in another object and each input parameter in the list can be linked to one or more output parameters in other objects. Each connection is made by selecting an output parameter with the mouse or other input device and dragging it to the desired input parameter. These connections can be selected, and then removed via a menu command. These input parameters and output parameters are both referred to as connection nodes. The list of connection nodes in the selected object window is numbered sequentially from 1. Graphical representations of these nodes are drawn as small rectangles along the edge of the object, in numerical order clockwise from the top of the object. The window for a selected object disappears when closed or when the object ceases to be selected. In some cases, a connection can be made between two nodes on the same object. Connections between nodes are constrained by the type and number of input and output parameters. Nodes with different message codes cannot be connected. When the user selects a node, all of the nodes with the same message code are highlighted on the screen to show the nodes that the current node can form valid connections with, as shown in FIG. 3. If the user attempts to form an invalid connection, an error message is displayed and the connection is not made.

The editor also has a feature whereby a user's inputs can be recorded as a script of commands. The editor can then execute this script to recreate the network of objects. This is useful if other people later wish to see how the user came up with their design. The scripting mechanism also allows other programs to use the editor via scripts. The script is a text file with one command per line, so that users can manually edit the text file if desired or create their own scripts. In the case of a script executed by another currently running program, each line can be sent directly to a port the editor can be set up to listen on without using a text file. Each line has an instruction, followed by the parameters for that instruction. The instructions are connect, move, disconnect, create, delete, and menu. Connect has six arguments: the x and y coordinates of the object to connect from, the connection node number to connect from, the x and y coordinates of the object to connect to, and the connection node number to connect to. All coordinates are in terms of pixels from the upper-left corner of the editing window. Move has four arguments: the x and y coordinates of the object to move and the x and y coordinates of the new location. Disconnect has six arguments: the x and y coordinates of the first connected object, the connection node number of that end of the connection, the x and y coordinates of the object connected to, and the connection node number on that end of the connection. Create has three arguments: the category name of the new object and the x and y coordinates of the new object. Delete has two arguments: the x and y coordinates of the object to be deleted. Menu normally has two arguments: the name of the menu selected and the name of the menu item selected in that menu. If a command occurs within a hierarchical submenu of a menu, the name of the submenu follows the name of the menu in the argument list. Menu commands that trigger any of the other described script actions do not generate a menu instruction in the script. All actions take place immediately upon execution. Illegal or nonsensical actions are ignored and an error entry is made in a log file.

The editor can be run simultaneously on multiple machines on a network. Each editor currently running can maintain an open network port for communications with other copies of the editor or other programs. By looking for open ports on other machines on a computer network, users of the editor can connect to edit the same network of objects. The computer with the port that each editor connects to is the server and the connecting computers are clients. When a client editor reads user input, the corresponding script line is sent to the port of the server and the server editor executes the line. When the server editor executes a script line or reads user input, the appropriate script line is sent to every client computer connected to the server port. Those clients then execute the script line. Note that when a client editor reads user input and generates the corresponding script line, it does not actually perform the action indicated by the user input until it receives the script line back from the server. This ensures that all changes to the network of objects are made in the same order on all machines editing that network.

This scripting format also allows new input methods to be added to the editor. For example, the editor supports a real-world interface where actual physical objects represent the objects in the network. In this case, “creating” an object means taking it out of the storage container and putting it on the editing surface. The storage container contains the objects in the database and has multiple objects of each type. “Deleting” an object means removing it from the editing surface. Each object contains a wireless transmitter that broadcasts the current location of the object and a list of what its inputs and outputs are connected to. If the object is in physical contact with the editing surface, it will also transmit that fact. A wireless receiver is attached to the computer, which uses the information provided by each object to update the current state of the network in the editor to reflect the information received.

An alternative embodiment supports a virtual reality interface by rendering the graphics in three dimensions using OpenGL instead of in two, using three-dimensional rendering information stored in the header information for each object in the database. This interface can be augmented with 3-D stereoscopic display goggles and force-feedback gloves for a more immersive experience.

After each user input, the editor calls the compiler to generate the appropriate machine control instructions for the network of connected objects in the editor. This continuous generation allows incremental development and testing but can be turned off during editing by the user to eliminate redundant or incomplete generation. If continuous generation is disabled, the user can still explicitly cause generation of the current network of objects in the editor via a menu command. If every output parameter node is not connected to another node, the unconnected output parameter nodes are considered to be connected to a null dummy object for purposes of generation. This allows generation to occur even on a partially connected or incomplete network of objects. The null object contains code to return zeros to any function calls made to it and performs no other actions. This assumption does not actually affect the network of objects in the editor; it is only used for purposes of generating the machine control instructions.

In the current embodiment, the machine control instructions are generated by copying the machine control instructions contained in the database entry for each object in the network. Some objects in the database may contain multiple sets of machine control instructions, but only the code for the currently selected instruction set in the editor is used and copied. When the user chooses or changes the desired instruction set, only the objects in the database containing code for the selected instruction set are included in the list of objects. If an object in the current network does not contain code for the newly selected instruction set, that object is removed from the network and all of its connections are destroyed and a user warning is displayed. Since the code stored in objects in the database can be optimized for efficiency, and since this code is copied directly, the generated code is highly efficient.

In the current embodiment, the code for each object is copied to a file in the target executable format. The executable format is the same format that the objects use in the database. In an alternative embodiment, this target format may be the equivalent source code. The code is copied successively from each object in the network. For smaller code, the editor can be configured so that only the functions with valid connections in the network are copied. In the current embodiment, this code is scanned for references to external objects, which appear as calls to a special hardware trap. Each of these trap calls is augmented by adding arguments with the class type and implementation code of the object that is connected to the connection node corresponding to that reference. In an alternative embodiment, the code in each object is executed instead with the appropriate class types and implementation codes as arguments and the return argument is a pointer to the list of machine control instructions generated by the executed code. In the case where the code is source code rather than executable machine instructions, the compiler can be set to either generate the source in the above manner or to generate machine instructions by compiling the generated source code. For some objects, the generated code simply loads a pre-existing run-time object into memory when executed.

When creating an executable file, the user must specify the entry point to the network of objects in the editor so that the compiler can mark the appropriate entry point in the created executable file. There are special entry and exit objects in the database specifically for this purpose. The entry object has an output connection node that will connect to any input connection node while the exit object has an input connection node that will connect to any number of output connection nodes on other objects. When generating an executable file, the compiler will display an error if more than one entry object is in the network, since normal programs only have a single entry point. When the program is run, the operating system begins execution at the input connection node that the entry point object is connected to. The code in the exit object terminates the program. If no entry object exists and there is only a single input connection node connected to the null dummy object as described earlier, this connection is viewed as being to an entry object rather than to the dummy object.

In addition to creating a program made up of the network of objects in the editor, the current embodiment can also create new objects made up of other objects in the network. If this option is chosen, then instead of creating a normal executable or source file, the compiler puts the generated code into a new object and adds that object to the database. Since the current embodiment has an executable format identical to the object format, this process is basically the same as the process of making an executable file, however the created object is automatically added to the database and therefore to the object list in the editor. This option also allows multiple entry objects to exist in the network. Any connection nodes connected to the dummy object or an entry object are assumed to be calls to external references and are automatically labeled with the message codes used by the known ends of the connections. The class type and implementation code of the generated object are obtained by prompting the local user or are specified as arguments to the menu command used to initiate the generation process, if generation was caused by executing a script command.

New objects can also be constructed by using a traditional compiler to generate the code, then manually or programmatically constructing the required header for the object and adding the object to the database.

The compiler also has the ability to take generated machine control instructions and decompose them into a network of objects that can be edited with the aforementioned editor. This approach can even be used on existing code written in a traditional development environment. The resulting network of objects can be modified in the editor and new code can be generated from it. Those skilled in the art will recognize that this allows a form of instruction translation to other formats, including source code, provided the necessary code is present in each object in the database used in the decompilation and generation process. This also allows the modification of the code contained in existing objects and allows complex objects to be broken down into several simpler objects. The decompilation feature can be triggered manually by user inputs through a menu command and the compiler uses this decompilation feature automatically to incorporate changes made to the generated machine control instructions.

In the current embodiment, the compiler begins the decompilation process by reading in all of the machine control instructions to decompose, function by function. The code in each function is compared with the code for the target platform stored in each object in the database. Each object containing a matching function is added to a queue, along with a pointer to the matching function. If no matches are found, the process is repeated on a subset of the code to decompose consisting of all the code in the current function except the last instruction. This process continues until the queue is non-empty at the end of a pass through the code in the functions of all of the objects in the database. Next, the process is repeated with a new queue and all of the remaining code in the function to decompose, or with the next function to decompose if all of the code in the current function has already been matched.

In the current embodiment, the database contains objects called “primitive objects” that only execute a single instruction. These objects generally have a single function that contains the instruction, where the function takes the input arguments to the instruction and the instruction's output arguments are returned as the output of the function. One such primitive object exists for each machine control instruction in the target instruction set. This ensures that even in the case in which the code to decompose has been shortened to a single machine control instruction, a match against at least one object is guaranteed. Since the database keeps track of the size of the code in each object, the large number of primitive objects does not slow down the search under normal operating conditions. An alternative embodiment uses a slightly slower approach, but with less space: it translates code into an intermediate form before comparing it. This intermediate form consists of a disassembly of each instruction to reduce the total number of possible instructions. The disassembly is done using the standard methods well known in the art. The translated code for each object is cached in the database along with each object to improve performance.

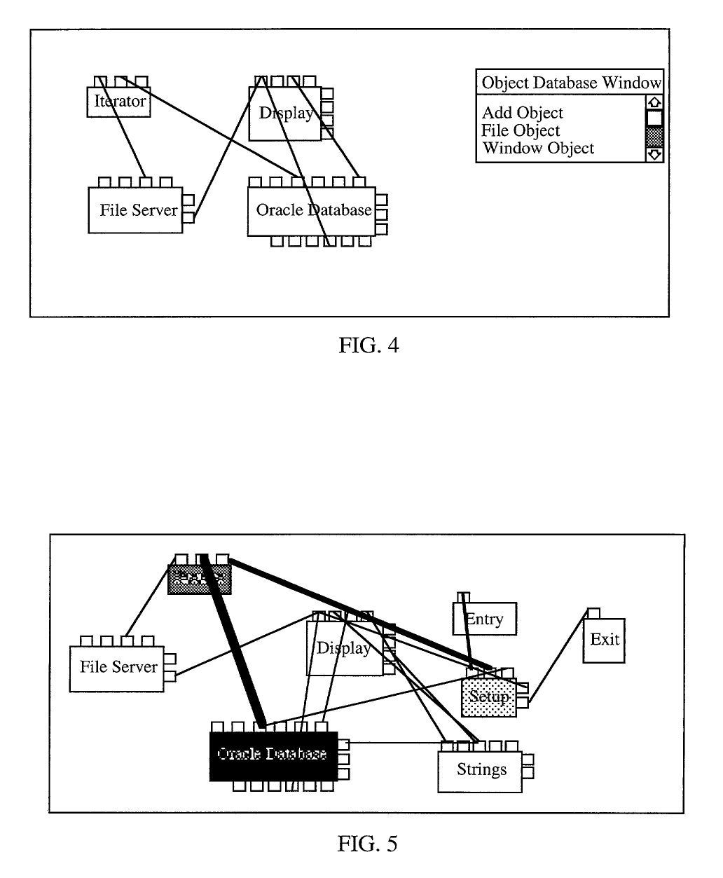

Once each function in the code to decompose has been divided into one or more segments and a queue with matching functions has been made for each code segment, the compiler tries each possible combination of functions from each queue and picks the combination that minimizes the total number of objects involved. The code corresponding to each matched function chosen is scanned for input and output parameters. Each input or output parameter to a matched function is connected to the input or output parameter in the matched function that corresponds to the code the scanned input and output parameters are connected to. If the parameters for the scanned code segment do not match those of the corresponding matched function segment, each successive match in the queue is tried instead. In the case where all of these matches fail, the queue is filled with the match of some subset of the original code as described above. The current embodiment graphically arranges the objects sequentially in the editor in as close to a square grid as possible, in the same order as they were identified during the scan, as shown in FIG. 4. As is well known in the art, there are many popular graphical layout techniques for representing networks; any of these could be used with the present invention. Since the connections for each function in an object are all on the same object in the network, multiple matched functions in the same object are represented by a single object in the network graph. Whenever code is decomposed in this manner, the entire network of objects is sent over the network to all connected editors to ensure changes made to code by one user are updated on every machine.

Whenever the editor generates code, it will automatically compare the generated code with the previously generated code, which is saved in a temporary buffer before writing it to a file. By comparing the temporary buffer from the last code generation with the file before generating code for the current network, the editor can determine which functions and code have been changed. These functions are decompiled as described above and the network is updated to reflect the changes. This allows the user to modify generated code while continuing to use the graphical editor on that code. The generated code can be modified using any desired tool or representation without affecting the ability of the automatic code generation system to decompose, edit, and regenerate the code.

In addition to the process of actually generating and modifying the machine control instructions, the current embodiment also supports a powerful debugging and modeling facility. The debugger has a graphical display containing the network produced in the editor. The debugger traps all calls between objects. Whenever such a call is detected, the debugger will highlight the appropriate connection line and connection nodes and the representation of the object about to be called, as shown in FIG. 5. The highlighting of the connection line and connection nodes will immediately start to fade at a constant rate to a lighter shade as execution continues, until the highlighting is completely gone five seconds later. The representation of the object will fade in the same manner at the same rate, but does not begin the fading process until after calling another object. If execution is halted, so is the fading process. The five second period is execution time, so time spent halted does not count towards the five seconds. This period and the highlighting color can be adjusted in the settings of the debugger.

To summarize the present embodiment of the invention, the editor reads in the users input from the user's preferred input devices. The user takes objects from a database and places them in a network and connects their inputs and outputs as desired. The editor uses the information in the database to constrain these connections to compatible ones. The compiler uses the information in the database to generate the code for the network of objects by writing out the appropriate code from the database for each object and compiling or executing it if necessary. When the resulting code is run on the operating system, the debugger allows the user to trace through and monitor the execution of the resulting code by visually indicating which object's code is currently executing and allowing the user to examine and manipulate that object. New objects can be generated and existing code can be modified using the same network editor by combining objects into larger objects or breaking code or objects down into sub-objects.

The resulting embodiment generates machine code instructions in a flexible and general manner to substantially reduce the time and resources required to produce production-quality software.

Those skilled in the art will recognize that the methods of the present invention may be incorporated as computer instructions stored as a computer program code means on a computer readable medium such as a magnetic disk, CD-ROM, and other media common in the art or that may yet be developed. Furthermore, important data structures found in computer hardware memory may be created due to operation of such computer program code means.

The foregoing description of one embodiment of the invention has been presented for the purposes of illustration and description. It is not intended to be exhaustive or to limit the invention to the precise form disclosed. Many modifications and variations are possible in light of the above teaching. The scope of the invention is, therefore, indicated by the appended claims rather than by the foregoing description. All changes which come within the meaning and range of equivalency of the claims are to be embraced within their scope.

I claim:

1. A method executed by a mechanical, electronic or computer system for generating machine control instructions, the method comprising the steps of:
reading in a user input to select an object from a library of objects, wherein the objects consist of sets of machine control instructions for performing one or more functions;
connecting the selected object to a network of objects consisting of those objects previously selected and connected by the user, including identifying the inputs and outputs of the selected object and connecting these inputs and outputs to the inputs and outputs of the other objects in the network;
generating machine control instructions using the instructions contained in the network of objects;
updating the network of objects and the connections in the network to accurately reflect any changes made to the generated machine control instructions or to the network of objects.

2. The method of claim 1, wherein the generation step and updating step are deferred until the user has completed constructing the entire network of objects.

3. The method of claim 1, wherein the functions contained in the objects are used to generate the corresponding sets of instructions for inclusion in the generated machine control instructions.

4. The method of claim 1, wherein the generated code consists of computer instructions to load the code libraries represented by the objects.

5. The method of claim 1, wherein the user is a computer program.

6. The method of claim 1, wherein the machine control instructions are computer instructions belonging to an instruction set architecture.

7. The method of claim 1, wherein the machine control instructions consist of source code in a computer programming or scripting language.

8. The method of claim 1, with the additional final step of translating or compiling the machine control instructions into another format of machine control instructions.

9. The method of claim 1, wherein the library of objects includes primitive operators for mathematical operations.

10. The method of claim 1, wherein the library of objects includes container objects that contain other objects or data.

11. The method of claim 1, wherein the user input is generated by the manipulation of graphical depictions of objects on a computer or video display screen or monitor, said manipulation being controlled by a computer mouse or a keyboard or some combination of a computer mouse and keyboard.

12. The method of claim 1, wherein the user inputs include the manipulation in physical space of virtual representations of the objects, provided by a virtual reality system.

13. The method of claim 12, wherein the virtual reality system includes a force-feedback or haptic interface.

14. The method of claim 1, wherein the user input consists of the movement and connection of physical objects in physical space corresponding to objects in the library.

15. The method of claim 1, further consisting of the step of removing any number of objects from the network in response to user inputs.

16. The method of claim 1, further consisting of the step of modifying existing connections of objects in the network in response to user inputs.

17. The method of claim 1, further consisting of the step of monitoring or tracing the path of data flow and execution of the generated code by visually indicating activity in active objects in the network.

18. The method of claim 1, wherein the user inputs are provided by at least one user over a network connection.

19. The method of claim 1, wherein said step of updating the network of objects includes updating the network of objects to reflect changes made by at least one remote user over a network connection.

20. The method of claim 1, further consisting of the step of creating at least one new object of machine control instructions from the generated code.

21. A method for constructing a high-level object model from generated machine control instructions, the method comprising the steps of:
reading in a sequence of machine control instructions for performing one or more functions;
searching a library of objects for one or more objects that generate the sequence of machine control instructions read;
parsing each matched sequence of machine control instructions to determine the objects connected to the inputs and outputs of each matching object found in the library of objects;
connecting each matched object found in the library of objects to the other objects in the high-level model found in the previous steps.

22. The method of claim 21, wherein the original machine control instructions were generated from a source file by a compiler.

23. The method of claim 21, wherein the user is a computer program.

24. The method of claim 21, with the additional final step of generating machine control instructions from the high-level model.

25. The method of claim 24, wherein the format of the newly generated machine control instructions differs from that of the original machine control instructions.

26. The method of claim 21, further consisting of the step of modifying connections of objects in the network in response to user inputs.

27. The method of claim 21, further consisting of the step of monitoring or tracing the path of data flow and execution of the generated code by visually indicating activity in active objects in the network.

28. The method of claim 21, wherein the user inputs are provided by at least one user over a network connection.
